(19) United States
(12) Patent Application Publication
(10) Pub. No.: US 2015/0240612 A1
(43) Pub. Date: Aug. 27, 2015

(54) Acid Fracturing With Shapeable Materials

(71) Applicants: Diankui Fu, Kuala Lumpur (MY); Irina Aleksandrovna Lomovskaya, Novosibirsk (RU); Vladimir Alexandrovich Plyashkevich, Novosibirsk (RU); Vadim Kamil'evich Khlestkin, Novosibirsk (RU)

(72) Inventors: Diankui Fu, Kuala Lumpur (MY); Irina Aleksandrovna Lomovskaya, Novosibirsk (RU); Vladimir Alexandrovich Plyashkevich, Novosibirsk (RU); Vadim Kamil'evich Khlestkin, Novosibirsk (RU)

(21) Appl. No.: 14/427,998

(22) PCT Filed: Sep. 13, 2012
(86) PCT No.: PCT/RU2012/000760

§ 371 Date: Apr. 27, 2015

(51) Int. Cl. E21B 43/26; C09K 8/68

(52) U.S. Cl. CPC E21B 43/26; C09K 8/68

(57) ABSTRACT

Elongated shapeable particles, for example bi-component fibers that are reshaped into tighter structures when heated, are injected into fractures generated during acid fracturing. Collections of such particles form as the temperature in the fracture increases, heterogeneously masking portions of the fracture faces and causing differential etching and increased fracture conductivity when formation-dissolving agents contact the fracture faces. Optionally, the elongated shapeable particles may decompose to release formation-dissolving agents.

### BACKGROUND

The statements in this section merely provide background information related to the present disclosure and may not constitute prior art.

Embodiments relate to acid fracturing, which is a hydraulic fracturing stimulation treatment most commonly performed in carbonate formations. The objective is to etch the open faces of induced fractures by dissolving rock, for example using a hydrochloric acid treatment. When the fracturing and dissolution treatment is complete and the fracture closes, the etched surfaces provide high-conductivity flow paths from the reservoir to the wellbore.

To form highly conductive channels, the surface of the carbonate rock should be etched unevenly (also called differential etching). This is typically achieved by a viscous fingering effect through pumping first a more viscous fluid and then a less viscous acid. Unfortunately, the viscous fingering effect diminishes with prolonged pumping, for example deep inside the fracture.

Another challenge facing acid fracturing treatment is the fast reaction rate of acid with carbonate rock, especially under high temperature conditions. Most acids tend to be spent near the wellbore region of the fracture, leaving the front end of the fracture (farthest from the wellbore) untreated. This, in general, can be addressed with retarded acids or organic acids. However, those acids may suffer from either high cost and/or low dissolving power.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter. One embodiment is a method of treating an underground formation penetrated by a wellbore including the steps of injecting into the formation a fluid containing a multiplicity of shapeable elongated particles at a pressure sufficient to fracture the formation, placing the shapeable particles inside a fracture, and allowing the shapeable particles to undergo a change in shape and to form collections of reshaped particles heterogeneously distributed within the fracture. The collections of reshaped particles mask portions of the fracture faces; a formation-dissolving fluid is injected into the fracture, and the fracture is allowed to close.

Another embodiment is a method of treating an underground formation penetrated by a wellbore including the steps of injecting into the formation a fluid comprising a multiplicity of shapeable elongated particles at a pressure sufficient to fracture the formation, placing the shapeable particles inside a fracture, and allowing the shapeable particles to undergo a change in shape and to form collections of reshaped particles heterogeneously distributed within the fracture in contact with portions of the fracture faces, in which the shapeable elongated particles are a source of formation dissolving agent. The shapeable elongated particles are allowed to generate a formation dissolving agent and the fracture is allowed to close.

Yet another embodiment is a method of treating an underground formation penetrated by a wellbore including the steps of injecting into the formation a fluid containing a source of a formation dissolving agent and a multiplicity of shapeable elongated particles at a pressure sufficient to fracture the formation, placing the shapeable particles inside a fracture, allowing the shapeable particles to undergo a change in shape and to form collections of reshaped particles heterogeneously distributed within the fracture that mask portions of the fracture faces, allowing the source of the formation dissolving agent to generate the formation dissolving agent, and allowing the fracture to close.

### BRIEF DESCRIPTION OF THE DRAWINGS

Embodiments are described with reference to the following figures. The same numbers are used throughout the figures to reference like features and components.

FIG. 1 shows schematically a change in structure of a loose collection of fibers into a tighter ball-like structure.

FIG. 2 illustrates schematically how reshaping of fibers in a collection in a fracture masks a portion of the fracture surface.

FIG. 3 shows schematically an embodiment in which acid etches portions of a fracture surface not masked by a reshaped fiber collection and then the reshaped fiber collection is removed before the fracture closes.

FIG. 4 illustrates schematically an embodiment in which a collection of fibers that hydrolyze and generates acid is reshaped, the acid etches a portion of the fracture faces contacting the reshaped fiber collection as the fibers are reacted away, and the fracture closes.

### DETAILED DESCRIPTION

It should be noted that in the development of any actual embodiments, numerous implementation-specific decisions may be made to achieve the developer's specific goals, for example compliance with system- and business-related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating embodiments and should not be construed as a limitation to the scope and applicability. Embodiments may be described in terms of treatment of vertical wells, but are equally applicable to wells of any orientation. Embodiments may be described for hydrocarbon production wells, but it is to be understood that embodiments may be used for wells for production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range. It should also be understood that fracture closure includes partial fracture closure.

The discussion in this paragraph of possible alternatives to the presently disclosed embodiments merely provides context information related to the present disclosure and may not constitute prior art. Attempts have been made to improve acid penetration by using acid generating materials such as polylactic acid (PLA) as beads or other shapes, which are pumped into the formation in treatments analogous to hydraulic fracturing treatments with proppants. An example is disclosed in U.S. Patent Application Publication No. 20050113263. The beads do not undergo physical transformations under downhole conditions, with the exception of deformation under closure stress. U.S. Pat. No. 7,540,328 discloses a method of creating a fracture in a subterranean formation. The method includes the steps of (a) preparing a fluid containing a solid acid precursor (such as PLA or polyglycolic acid (PGA) or mixtures), hydrogen fluoride (HF) or a solid that releases hydrogen fluoride (such as ammonium fluoride or sodium tetrafluoroborate or mixtures) in the presence of aqueous acid, and inert particles in sufficient amount to form a masking material over portions of one or more fracture faces, creating a balance between masked areas and un-masked areas along the fracture face, (b) injecting the fluid into the formation above fracture pressure, and (c) allowing at least a portion of the solid acid-precursor to hydrolyze, and release hydrogen fluoride if it is not initially present, creating a dissolving system. The dissolving system removes rock from portions of one or both fracture faces that are not protected by the masking material, and the portions of fracture faces protected from dissolution create pillars between the fracture faces which hold open the fracture and create a highly conductive pathway. The solid that releases acid and the optional solid that releases HF may optionally be coated (for example with hydrocarbon) to delay the release. The fluid may be viscosified, may contain inert solid particles, and may be preceded with an optionally viscosified pad. US Patent Application Publication No. 20060058197 discloses a method of creating a fracture in a subterranean formation penetrated by a wellbore. The method includes the steps of: a) injecting above fracture pressure a fluid containing particles of a solid acid-precursor, and inert solid particles that can conform to one or both faces of the fracture and inhibit reaction of acid with the formation where they conform to a fracture face, and b) allowing at least a portion of the solid acid-precursor to hydrolyze. Optionally, the deformable particles may be made of a second solid acid-precursor that hydrolyzes and dissolves to generate acid at a different rate from the first solid acid-precursor.

We disclose here a new class of materials for use in acid fracturing. These materials can heterogeneously modify a fracture surface of the formation rock and/or place an acid generating material heterogeneously inside the fracture during acid fracturing treatments. We have developed the use of these materials, that we designate shapeable materials, in particular shapeable elongated particles, in particular shrinkable fibers, to alter the rock surface heterogeneously and/or to position acid generating material heterogeneously inside the fracture. Although most of the following discussion is directed toward acid fracturing of carbonates with acids, for example with hydrochloric acid or acetic acid, or with delayed or retarded acids, such as emulsified or gelled acids or certain mixtures, embodiments also include acid fracturing of sandstones with acids that include hydrofluoric acid (HF) or HF sources, and fracturing of formations with fluids containing other chemicals (for example chelating agents, for example hydroxy-aminocarboxylic acids including hydroxyethylethylenediaminetriacetic acid (HEDTA), hydroxyethyliminodiacetic acid (HEIDA), ethylenediaminetetraacetic acid (EDTA), diethylenetriaminepentaacetic acid (DTPA), nitrilotriacetic acid, mixtures of these, and others) that at least partially dissolve some components of formations.

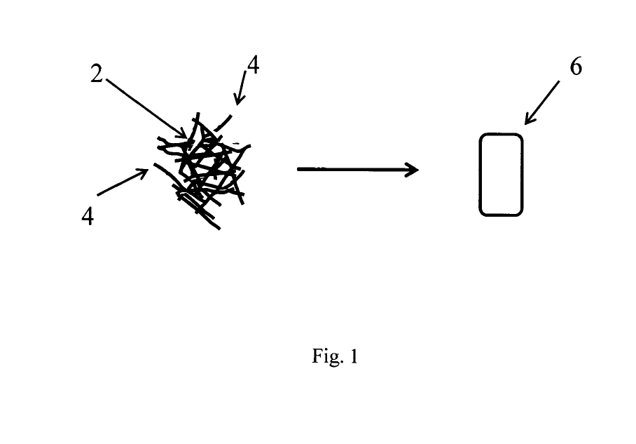

We define elongated particles as particles having an aspect ratio of at least about 20, for example fibers having a length greater than about 20 times their diameter, for example fibers having an aspect ratio of at least 200. Some elongated particles, for example certain fibers, undergo physical changes, for example from long extended shapes to contracted structures, at certain temperatures. FIG. 1 shows schematically a change upon heating in the initial structure of a loose aggregation or collection [2] of individual fibers [4] in their initial shapes into a tighter ball-like subsequent structure [6] made up of fibers in their subsequent shapes. It is known that many plastic or thermoplastic materials undergo such transformations when heated. For example, in addition to fibers, elongated shapeable particles include films (sheets), platelets (flakes), ribbons and other shapes formed from suitable materials may crumple up into contracted shapes.

We define the three-dimensional structure of a shapeable material when the shapeable material is initially mixed with a fluid, pumped downhole, and deposited in a subterranean location in a wellbore or in a formation, as the “initial shape” and the three-dimensional structure of the shapeable material after reshaping of the shapeable material as the “subsequent shape”. We define the three-dimensional structure of an accumulation of shapeable materials, and optionally other solid materials mixed with the shapeable materials, when this accumulation is initially deposited in a subterranean location in a wellbore or in a formation, as the “initial structure” and the three-dimensional structure of the shapeable materials, and optionally other solid materials mixed with the shapeable materials, after reshaping of the shapeable materials as the “subsequent structure”.

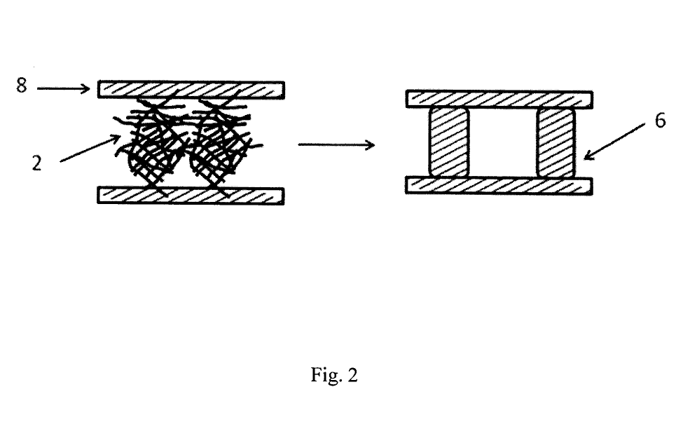

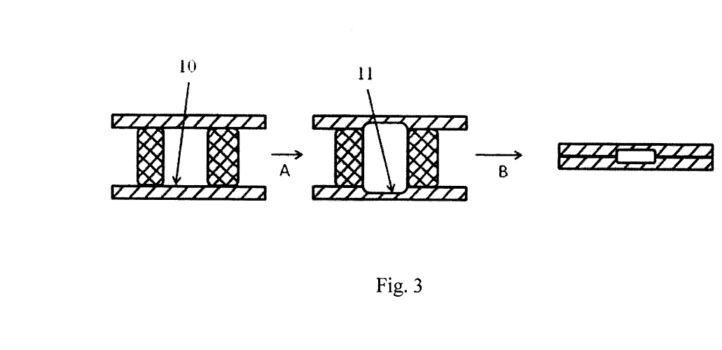

In one embodiment, we disclose the placement of shapeable materials in fractures during acid fracturing treatments to mask the rock surfaces heterogeneously. FIG. 2 shows schematically how collections [2] of particles of certain shapes, such as fibers, may be placed in a fracture between the fracture faces [8] and then are allowed to, or caused to, be reshaped into tighter structures [6] that mask part of the fracture surface, for example by heat. By “masking” a surface, we mean covering a portion of the surface and thus reducing the extent of contact of fluids with portions of the surface. FIG. 3 shows schematically that when acid is then injected into the fracture, the unmasked portions of the fracture surface [10] (not in contact with the reshaped tighter structure of reshapeable elongated particles) are preferentially etched at exposed locations [11] (step A); then the reshaped particles are allowed to, or caused to, be removed and the fracture is allowed to close (step B). The material does not have to be removed in most embodiments because it is not strong enough to prevent fractures from closing; the material will in most embodiments deform again under closure stress. However, the collections of particles may optionally be removed by flow back, dissolution, degradation, melting, or any other suitable method. Note that optionally, in another embodiment, some or all of the collection of reshaped particles may be left in the fracture.

Note that it is not necessary, to place the shapeable materials heterogeneously in a fracture, although it is within the scope of the various embodiments to do so. In most embodiments, the heterogeneity is created by the reshaping of the particles.

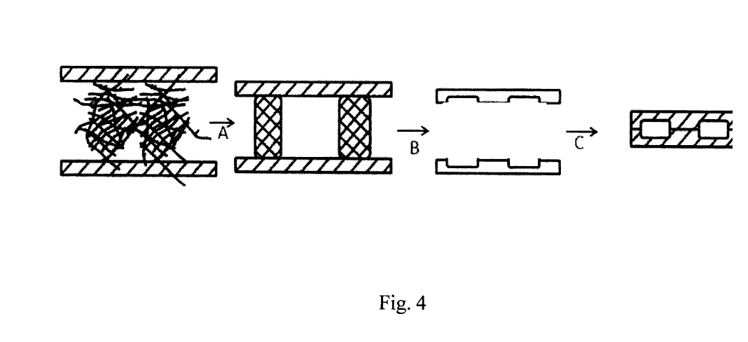

In yet another embodiment, we disclose the use of a material that is both shapeable and acid-generating during an acid fracturing treatment, for example amorphous PLA fibers. In such a case, as shown schematically in FIG. 4, the material is placed in the fracture heterogeneously due to the physical transformation. Collections [2] of acid-generating particles of certain shapes, such as fibers, may be placed in a fracture between the fracture faces [8] and then (step a) are allowed to, or caused to, be reshaped into tighter structures [6]. The collection is then allowed to, or caused to, degrade and generates acid to remove the rock surface [12] that is in contact with the acid generating material (step B). The fracture is then allowed to close (step C).

Note that in all of these embodiments, other types of particles may be mixed with the elongated shapeable particles. For example, elongated shapeable particles that do not generate formation-dissolving agents may be mixed with inert particles of any shape (for example fluid loss control agents and/or proppants and/or flow-assisting fibers), chemically active particles of any shape (such as encapsulated breakers and/or scale control agents), and particles of any shape, including shapeable, that generate formation-dissolving agents (for example PLA beads or benzoic acid flakes). Similarly, elongated shapeable particles that do generate formation-dissolving agents may be mixed with inert particles of any shape (for example fluid loss control agents and/or proppants and/or flow-assisting fibers), chemically active particles of any shape (such as encapsulated breakers and/or scale control agents), and particles of any shape that generate formation-dissolving agents.

Although the term “acid” is generally used here to describe agents capable of dissolving components of a formation, it is to be understood that other reactive fluids (such as chelating agents, for example aminocarboxylic acids, polyaminopolycarboxylic acids, etc.) may also be used, and the term “acid” is intended to include such materials. Embodiments may in fact be used with any dissolution agent (including those that are delayed, or retarded (gelled, or emulsified)) for any subterranean formation lithology, provided only that a shapeable elongated particle is chosen that either generates a dissolution agent after it reshapes or is suitably inert in the dissolution agent before or while differential etching takes place (and does not excessively interfere with its efficacy). The method is particularly suitable for use with expensive dissolution agents because the method increases the dissolution efficiency and therefore reduces the amount of dissolution agent needed. On the other hand, the need for delay or retardation is reduced with the present method.

In some embodiments disclosed, dissolving systems are not allowed to react with some portions of the fracture face, while still reacting with, and etching, other portions of the fracture face. In some embodiments, during the treatment, portions of the fracture face are protected from acid dissolution by being masked by the shapeable elongated particles. This process of masking the formation (similar to the process performed during photolithography) protects a portion of the fracture face from dissolution and ultimately leaves behind a supporting “pillar” that acts something like the proppant in hydraulic fracturing and helps to keep the fracture open. The dissolving system removes some rock from any portion of the fracture face that is not protected by the masking material. With a balance of masked and un-masked areas along the fracture face, a highly conductive pathway is created using the supporting pillars to hold open the fracture in a method analogous to a “room and pillar” mine. This results in a conductive pathway even if the fluid flow and reaction rates are in one of the regimes in which the dissolution of the fracture face would otherwise be comparatively uniform. The shapeable elongated particles may also serve as a fluid loss additive to reduce the volume of fracturing/dissolving fluid needed.

In an embodiment, in order to create large pillar structures, it may be desirable to pump slugs of shapeable elongated particles. That is, the concentration of shapeable elongated particles in the fracturing fluid may be varied during the treatment and may even be zero during part of the treatment.

Treatments are optionally conducted as cost-minimization water fracs in which a low concentration, for example about 0.05 kg/L, of inert material is pumped at a high rate, for example up to about 3500 L/min or more, with little or no viscosifier. Optionally they are also conducted, as are more conventional fracturing treatments, with viscosifiers and higher concentrations of shapeable elongated particles. The preferred concentration range is between about 0.42 and about 5 ppg (between about 0.05 and about 0.6 kg/L). The most preferred range is between about 0.83 and about 2.5 ppg (between about 0.1 and about 0.3 kg/L) of shapeable elongated particles or mixtures with other solids. Care must be exercised to prevent bridging (screening out) of any solid material unless it is desired at some point; one skilled in the art will know that for a given particle shape, flow rate, rock properties, etc. there is a concentration, that can be calculated by one of ordinary skill in the art, above which bridging may occur. The viscosifiers, if used, are the polymers or viscoelastic surfactants typically used in fracturing, frac-packing and gravel packing. The lower density of many types of shapeable elongated particles, relative to the density of conventional proppants, is an advantage since the amount of viscosifier needed is less. Acid usually also acts as a breaker for the viscosifier, thus enhancing cleanup and offsetting any damage that might otherwise be done by the viscosifier. (Acids are known to damage or destroy many synthetic polymers and biopolymers used to viscosify drilling, completion and stimulation fluids. Acids are also known to damage or destroy either the micelle/vesicle structures formed by many viscoelastic surfactants or, in some cases, the surfactants themselves.)

Embodiments may be used with any dissolution agent for any lithology. By non-limiting example, hydrochloric acid, acetic acid, and the like are typically used for carbonates; chelating agents such as hydroxyethylethylenediamine triacetic acid (HEDTA) and hydroxyethyliminodiacetic acid (HEIDA) can also be used for carbonates, especially when acidified with hydrochloric acid; and mud acid (hydrochloric acid mixed with hydrofluoric acid) and mud acid with acetic acid are commonly used for sandstones. Acids may be retarded by emulsification and gelling and/or delayed by using a precursor, especially for hydrofluoric acid, such as fluoboric acid, ammonium fluoride, and ammonium bifluoride. For sandstone treatment, as is known in the art, if the formation contains any carbonate it is common to pretreat (preflush) the formation with an acid such as hydrochloric acid to dissolve the carbonate and then, if necessary, inject a spacer such as ammonium chloride to push dissolved materials away before injection of the fluoride-containing fluid so that fluoride ion does not contact cations such as sodium, calcium and magnesium which could precipitate. If the dissolution agent contains sufficient chelating agent, the preflush may not be necessary. A typical embodiment for creating differential etching with partial fracture surface masking involves pumping of a mixture containing shapeable elongated particles, an inorganic or organic acid, a fluoride containing chemical and an optional viscosifying agent into a sandstone reservoir at above fracturing pressure.

Excellent solid acid-precursors, or sources, are the solid polymers of certain organic acids, that hydrolyze under known and controllable conditions of temperature, time and pH to form the organic acids. One example of a suitable solid acid-precursor is a polymer of lactic acid, (sometimes called a polylactic acid (or “PLA”), or a polylactate, or a polylactide). Another example is a polymer of glycolic acid (hydroxyacetic acid), also known as polyglycolic acid (“PGA”), or polyglycolide. Another example is a copolymer of lactic acid and glycolic acid; various copolymers of lactic acid and glycolic acid are often called “polyglactin” or poly(lactide-co-glycolide). Also suitable are copolymers of PLA or PGA with other hydroxy-, carboxylic acid-, or hydroxycarboxylic acid-containing moieties. Any of these materials can be used to make shapeable elongated particles.

Typically in fracturing treatments, injection of a fluid ahead of the main treatment fluid is employed to create fracture width. A pad is generally used in the present embodiments to ensure that the fracture is wide enough for the solid shapeable elongated particles to enter, but optionally the operator may omit the pad stage and put the shapeable elongated particles straight into the acid (or mix them with the acid precursor) provided that the acid or acid precursor-carrying fluid has sufficient viscosity to create width and to suspend the shapeable elongated particles. The pad may be any viscous fluid, as examples polymer, crosslinked polymer, VES, and foam, and may itself comprise a formation dissolving material and or a clay control agent.

Some single-component materials, for example PLA fibers, are shrinkable; in general, fibers made from many amorphous polymers may be shrinkable. Most suitable shapeable materials are typically multicomponent materials, for example multicomponent fibers, for example two-component fibers. The initial shapes of suitable shapeable materials include fibers, films, ribbons, platelets, flakes and other shapes having an aspect ratio of greater than about 20 (the aspect ratio of a flake, ribbon or film is the ratio of the average surface area to the average thickness). Common structures of multicomponent fibers, for example side-by-side, sheath-core, segmented pie, islands-in-the-sea, and combination of such configurations, and methods of forming such multicomponent fibers, are well known to those of ordinary skill in the art of making fibers. For example, such fibers and methods of making them are described in U.S. Pat. No. 7,851,391. The differences in the compositions of the different components, and their consequent differences in behavior when subjected to changes in conditions downhole (such as differences in shrinkage or elongation with differences in temperature or with sorption of fluids such as oil and water or, with differences of sorption of fluids such as oil and water, or with changes in pH or salinity) are responsible for the changes in shape.

In various embodiments, shapeable materials may be used alone or mixed with a choice or mixture of chemically active and/or chemically inert materials. By non-limiting example, shapeable elongated particles (including shapeable elongated particles that either are or are not sources of formation dissolving agents) may be used with only a carrier fluid; they may be used in a carrier fluid mixed with inert solids (such as proppant or fluid loss agents) and/or mixed with solid, or liquid, or dissolving chemically active agents (such as formation dissolving agents, sources of formation dissolving agents, and breakers); and they be used in carrier fluids in separate steps along with steps in which other fluids containing inert or active solids, liquids, or dissolving solids are injected.

Following are non-limiting examples of shapeable materials that may be used in embodiments disclosed herein. For shrinkable materials, shrinkage of from about 20 to about 80 per cent is preferred; shrinkage of from about 40 to about 70 per cent is more preferred, although less or more shrinkage is suitable. Other suitable materials may readily be identified or conceived of by readers of this disclosure.

One example of suitable shapeable material is two-component fibers made of a core material and a sheath material that have different melting points. The core material (for example a thermoplastic resin, for example a polypropylene or a polyester) normally is used to ensure the integrity of the material during use; this core is not normally melted as the shapeable material is reshaped, and may, for example, form a three-dimensional network in the newly shaped subsequent structure, giving the subsequent structure strength. The sheath material (for example a thermoplastic resin, for example a polyethylene) has a lower melting and bonding temperature and thus may be used to hold the subsequent structure together and in the new shape. The melting point of the sheath material may be about 80° C.; the melting point of the core material may commonly be up to about 160° C. Such materials may be manufactured with the sheath and core eccentric or concentric, and the fibers may be available in conventional form or available commercially already in a crimped (zigzag), wavy, or spiral form. Such fibers are available, for example, from ES Fibervisions™. Such shrinkable fibers are described in U.S. Patent Application Publication No. 2010/0227166.

Another example of suitable shapeable materials is highly shrinkable copolyamide fiber (having high wet heat shrinkage characteristics and low dry heat shrinkage characteristics) as disclosed by Toray Industries, Inc. An example of a suitable fiber is described in JP08209444. Another example is a staple fiber obtained by extruding a copolyester including (A) isophthalic acid and (B) 2,2-bis{4-(2-hydroxyethoxy)phenyl}propane as copolymerizing components, as described in JP10204722. This latter fiber undergoes less than or equal to 20 percent shrinkage in boiling water, and 12 to 40 percent shrinkage in 160° C. dry air after treating in boiling water.

Yet another example of suitable shapeable materials is a polyester fiber having a diol component and a dicarboxylic acid component; for example the diol may be 1,1-cyclohexanedimethanol or its ester-forming derivative (or biphenyl-2,2′-dicarboxylic acid or its ester-forming derivative) in an amount of 2 to 20 mole percent based on the whole dicarboxylic acid component. Such fibers were disclosed by Kuraray in JP 9078345 and JP 8113825. Other suitable materials from Kuraray include the polyester fibers described in U.S. Pat. No. 5,567,796.

Nippon Ester Company Ltd. has described several fibers suitable for use as shapeable materials. A highly shrinkable conjugated fiber disclosed in Japanese Patent Application No. JP 2003-221737 is composed of a polyester, A, containing polyethylene terephthalate as a main component (prepared by copolymerizing an aromatic dicarboxylic acid having a metal sulfonate group in an amount of from 3 to 7 mole percent based on the whole acid component or an isophthalic acid in an amount of from 8 to 40 mole percent) and a polyester, B, that is ethylene terephthalate. The difference in melting point between polyester A and polyester B is at least 5° C. and the difference between the heat of melting of polyester A and polyester B is at least 20 J/g. The dry heat shrinkage at 170° C. is at least 15 percent. Another fiber described by Nippon Ester Company Ltd. in Japanese Patent No. JP 08035120 is a highly shrinkable polyester conjugated fiber obtained by conjugate spinning in a side-by-side fashion of polyethylene terephthalate and a polyethylene terephthalate copolymerized with 8 to 40 mole percent of isophthalic acid at a weight ratio of from 20:80 to 70:30. The product having a single fiber fineness of 1 to 20 denier has a hot water shrinkage at 90° C. of from 70 to 95 percent.

Kaneka Corporation has described several fibers suitable for use as shapeable materials in embodiments described herein in U. S. Patent Application Publication No. 2002/0122937 and U.S. Pat. No. 7,612,000. They include a hollow shrinkable copolymer fiber made of acrylonitrile and a halogen-containing vinyl monomer manufactured by wet spinning followed by steam treatment, drying, and heating. Some examples contain one or more of acrylic acid, methacrylic acid, vinyl chloride, vinylidene chloride, vinyl esters (for example vinyl acetate, vinyl pyrrolidone, vinyl pyridine and their alkyl-substituted derivatives), amides, and methacrylic acid amides. In these references, one of the monomers may be halogen-containing to provide fire-resistance to the fiber; in the present application, this is not necessary. Other examples are modacrylic shrinkable fibers made from 50 to 99 parts by weight of a polymer (A) containing 40 to 80 weight percent acrylonitrile, 20 to 60 weight percent of a halogen-containing monomer, and 0 to 5 weight percent of a sulfonic acid-containing monomer, and 1 to 50 parts by weight of a polymer (B) containing 5 to 70 weight percent acrylonitrile, 20 to 94 weight percent of an acrylic ester, and 16 to 40 weight percent of a sulfonic acid-containing monomer containing a methallylsulfonic acid or methallylsulfonic acid metal salt, and no halogen-containing monomer. Some examples of the fibers contain from 10 to 50 percent voids, and shrink at least 15 percent (and often over 30 percent) at from 100 to 150° C. in 20 minutes. They may be crimped before use.

KB Seiren Ltd. has described in U.S. Patent Application Publication No. 2010/0137527 a fiber that is suitable for shapeable materials. It is a highly shrinkable (for example in boiling water) fiber that is composed of a mixture of a nylon-MXD6 polymer (a crystalline polyamide obtained from a polymerization reaction of metaxylenediamine and adipic acid) and a nylon-6 polymer in a weight ratio of from 35:65 to 70:30. The fiber is made by melt spinning and drawing or draw-twisting. The fiber shrinks 43 to 53 percent in hot water at from 90 to 100° C. Inorganic particles, for example TiO₂, may be added to improve the spinning process.

Shimadzu Corporation described in U.S. Pat. No. 6,844,063 a core-sheath conjugated fiber, that is suitable as a shapeable material, made from a sheath of (A) a low heat-shrinkability component that is a highly crystalline aliphatic polyester (having a melting point above 140° C.) and a core of (B) a high heat-shrinkability polymer containing at least 10 percent by weight of a low crystallinity aliphatic polyester having a melting point lower than that of component (A) by at least 20° C. The difference in shrinkability is at least 3 percent, preferably 5 to 70 percent, and more preferably about 10 to about 50 percent.

Kanebo Ltd. described, in Japanese Patent No. JP7305225, highly shrinkable polyester staple polymers obtained by melt-spinning a polymer made from a polyethylene terephthalate and subjecting it to specified melt-spinning drawing and post-treating processes under specified conditions. Examples are polyethylene terephthalate core-sheath structures with in which the core and sheath have different crystallinities.

U.S. Pat. No. 6,844,062 describes spontaneously degradable fibers and goods made with fibers having a core-sheath structure including (A) a low heat-shrinkable fiber component comprising a high crystalline aliphatic polyester and (B) a high heat-shrinkable fiber component comprising an aliphatic polyester, for example a low crystalline or non-crystalline aliphatic polyester. Examples of polymer (A) include homopolymers such as polybutylene succinate (melting point about 116° C.), poly-L-lactic acid (m.p. 175° C.), poly-D-lactic acid (m.p. 175° C.), polyhydroxybutyrate (m. p. 180° C.) and polyglycolic acid (m.p. 230° C.), and copolymers or mixtures of these with small amounts of other components. Polymer (B) is a component having a low crystallinity and a high heat shrinkability. The component used for the copolymerization or mixing with the homopolymers with high melting point such as polybutylene succinate, polylactic acid, polyhydroxybutyrate and polyglycolic acid can be suitably selected from the raw materials for the preparation of the above-mentioned aliphatic polyesters.

Yet another suitable shapeable material was described in U.S. Pat. No. 5,635,298. It is a monofilament having a core-sheath structure including a core of a thermoplastic polyester or copolyester and a sheath of a thermoplastic polyester, in which the polyester or copolyester of the core has a melting point of 200 to 300° C., preferably of 220 to 285° C., and includes at least 70 mole percent, based on the totality of all polyester structural units, of structural units derived from aromatic dicarboxylic acids and from aliphatic diols, and not more than 30 mole percent, based on the totality of all polyester structural units, of dicarboxylic acid units which differ from the aromatic dicarboxylic acid units which form the predominant portion of the dicarboxylic acid units, and diol units derived from aliphatic diols and which differ from the diol units which form the predominant portion of the diol units, and the sheath is made of a polyester mixture containing a thermoplastic polyester whose melting point is between 200 and 300° C., preferably between 220 and 285° C., and a thermoplastic, elastomeric copolyether-ester with or without customary nonpolymeric additives. The core-sheath monofilaments, if the core and sheath materials are separately melted and extruded, then cooled, then subjected to an afterdraw and subsequently heat-set, all under conditions as specified in the patent, preferably have a dry hear shrinkage at 180° C. of from 2 to 30 percent.

U.S. Pat. No. 5,688,594 describes a hybrid yarn, the fibers of which are suitable shapeable materials for embodiments described herein. The hybrid yarn contains at least two varieties of filaments: (A) has a dry heat shrinkage of less than 7.5%, and (B) has a dry heat shrinkage of above 10%. Appropriate heating forces the lower-shrinking filaments to undergo crimping or curling. (A) is, for example, aramid, polyester, polyacrylonitirile, polypropylene, polyetherketone, polyetheretherketone, polyoxymethylene, metal, glass, ceramic or carbon, and (B) is, for example, drawn polyester, polyamide, polyethylene terephthalate, or polyetherimide.

In general, the the lower limit for fiber diameter for typical shrinkable organic fibers is about 1.3 dtex (11 microns), which is based primarily on current manufacturing limitations. The upper limit is based on limitations of typical oilfield pumping equipment. On a weight basis, the larger the fiber diameter, the less the total fiber length that is pumped and the fewer fiber filaments are pumped. However, in embodiments described here, shapeable fibers are pumped with proppant; under such circumstances it is believed that 4.4 dtex fiber can be pumped with present-day equipment.

Embodiments may also include deformable particles that are not shapeable in the context used here but deform under fracture closure pressure to mask portions of the fracture faces. Embodiments may also include non-deformable masking materials such as plates or sheets, for example mica or plastic.

Any elements of the disclosed embodiments may be replaced by any one of numerous equivalent alternatives, only some of which are disclosed in the specification.

Embodiments can be further understood from the following examples.

### EXAMPLE 1

A homogeneous aqueous slurry containing 2.4 g/L of linear guar gel, and 12 g/L of polylactic acid shrinkable sheath/core fibers (Trevira T266 series (PLA/PLA 50/50 crystalline core/amorphous sheath), 6 mm in length and 14 microns (1.7 dtex) in diameter) was placed in a flat slot (two panes of PLEXIGLASS™ organic glass 10 mm apart). The inner slot size was 220×220×6 mm, enclosing a volume of about 330 ml. The slot was placed horizontally in an oven at 82° C. (180° F.). After one hour, fiber flocs approximately 3 to 6 cm in diameter were found in the slot, with channels free of fibers between the flocs.

### EXAMPLE 2

A homogeneous aqueous slurry containing 2.4 g/L of linear guar gel, and 12 g/L of polylactic acid shrinkable sheath/core fibers (Trevira T266 series, 6 mm in length and 17 microns (2.2 dtex) in diameter) was placed in a flat slot (two panes of PLEXIGLASS^{TM} organic glass 10 mm apart). The inner slot size was 220×220×6 mm, enclosing a volume of about 330 ml. The slot was placed horizontally in an oven at 82° C. (180° F.). After one hour, fiber flocs approximately 3 to 6 cm in diameter were found in the slot, with channels free of fibers between the flocs.

### EXAMPLE 3

A homogeneous aqueous slurry containing 2.4 g/L of linear guar gel, and 12 g/L of polylactic acid shrinkable sheath/core fibers (Trevira T266 series, 6 mm in length and 22 microns (4.4 dtex) in diameter) was placed in a flat slot (two panes of PLEXIGLASS™ organic glass 10 mm apart). The inner slot size was 220×220×6 mm, enclosing a volume of about 330 ml. The slot was placed horizontally in an oven at 82° C. (180° F.). After one hour, fiber flocs approximately 3 to 6 cm in diameter were found in the slot, with channels free of fibers between the flocs.

Examples 1, 2, and 3, show that the fiber diameter does not play a significant role in the pillar and channel formation; similar flocks were formed in all cases.

### EXAMPLE 4

Polylactic acid shrinkable sheath/core fibers (Trevira T266 series, 6 mm in length and 17 microns in diameter) were placed in 100 mL glass bottles to obtain 4.8 g/L solutions with several different water-based fluids: (a) neutral deionized water, (b) 5.40 g/L of neutral linear guar gel solution, and (c) 5.40 g/L linear guar gel solution with 1.2 ml of borate-based alkaline cross-linking agent (pH=12). The bottles were placed in a water bath at 82° C. (180° F.). After 30 minutes, shrunken fiber balls of about 2 cm and 3.5 cm in diameter were found in the two neutral and the alkali solutions, respectively. The fiber ball samples were dried in an oven at 60° C. overnight and the fiber mass loss was measured. The fiber balls in samples (a) and (b) contained 100% of the fiber mass originally present in each; the fiber balls in sample (c) contained 40% of the initial fiber mass.

### EXAMPLE 5

Polylactic acid shrinkable sheath/core fibers (Trevira T266 series, 6 mm in length and 22 microns in diameter) were placed in 100 mL glass bottles to obtain 4.8 g/L solutions with several different water-based fluids: (a) neutral deionized water, (b) 5.40 g/L of neutral linear guar gel solution, and (c) 5.40 g/L linear guar gel solution with 1.2 ml of borate-based alkaline cross-linking agent (pH=12). The bottles were placed in a water bath at 82° C. (180° F.). After 30 minutes, shrunken fiber balls of about 2 cm in diameter were found in the bottles. The fiber ball samples were dried in an oven at 60° C. overnight and the fiber mass loss was measured. The fiber balls in samples (a) and (b) contained 100% of the fiber mass originally present in each; the fiber balls in sample (c) contained 95% of the initial fiber mass.

It is believed that in the alkali cross-linked fluids, the 17 micron fibers underwent some degradation, while the 22 micron fiber was much more stable.

### EXAMPLE 6

A homogeneous aqueous slurry containing 5.4 g/L of linear guar gel, and 6 g/L of polylactic acid shrinkable sheath/core fibers (Trevira T266 series, 6 mm in length and 22 microns (4.4 dtex) in diameter) and 240 g/L of polylactide resin 6251D PLA beads were placed in the flat slot described in the previous examples. The slot was placed horizontally in an oven at 82° C. (180° F.). After one hour, fiber-bead flocs approximately 5 to 10 cm in diameter were found in the slot, with channels free of fibers between the flocks.

Example 6 shows that not only fiber alone but fluid containing a mixture of fiber and solid acid precursor beads (for example PLA) may be used to create larger pillars. Furthermore, we have found that by varying the size and/or amount of the solid acid precursor particles, an operator can easily vary the size of pillars.

Any element in the examples may be replaced by any one of numerous equivalent alternatives, only some of which are disclosed in the specification. Although only a few example embodiments have been described in detail above, those skilled in the art will readily appreciate that many modifications are possible in the example embodiments without materially departing from the concepts described herein. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

We claim:

1. A method of treating an underground formation penetrated by a wellbore comprising the steps of injecting into the formation a fluid comprising a multiplicity of shapeable elongated particles at a pressure sufficient to fracture the formation, placing the shapeable particles inside a fracture, allowing the shapeable particles to undergo a change in shape and to form collections of reshaped particles heterogeneously distributed within the fracture, wherein the collections of reshaped particles mask portions of the fracture faces, and injecting a formation-dissolving fluid into the fracture, and allowing the fracture to close.

2. The method of claim 1 wherein the shapeable elongated particles are selected from the group consisting of fibers, sheets, platelets, films, ribbons, flakes and mixtures of these shapes.

3. The method of claim 1 wherein the shapeable elongated particles are shrinkable particles.

4. The method of claim 1 wherein the shapeable elongated particles are multicomponent particles.

5. The method of claim 1 wherein the shapeable elongated particles are at least partially removed during or after the step of injecting a formation-dissolving fluid into the fracture.

6. The method of claim 1 wherein the composition of the shapeable elongated particles is selected from the group consisting of polymers and copolymers of the group consisting of polyesters and polyolefins.

7. The method of claim I wherein the fluid comprising a multiplicity of shapeable elongated particles further comprises non-shapeable particles.

8. The method of claim 1 wherein the non-shapeable particles comprise particles that decompose to generate a formation-dissolving agent.

9. A method of treating an underground formation penetrated by a wellbore comprising the steps of injecting into the formation a fluid comprising a multiplicity of shapeable elongated particles at a pressure sufficient to fracture the formation, placing the shapeable particles inside a fracture, allowing the shapeable particles to undergo a change in shape and to form collections of reshaped particles heterogeneously distributed within the fracture in contact with portions of the fracture faces, allowing the collections of reshaped particles to generate a formation dissolving agent, and allowing the fracture to close.

10. The method of claim 9 wherein the shapeable elongated particles are selected from the group consisting of fibers, sheets, platelets, films, ribbons, flakes and mixtures of these shapes.

11. The method of claim 9 wherein the shapeable elongated particles are shrinkable particles.

12. The method of claim 9 wherein the shapeable elongated particles are multicomponent particles.

13. The method of claim 9 wherein the composition of the shapeable elongated particles is selected from the group consisting of polymers and copolymers of the group consisting of polyesters and polyolefins.

14. The method of claim 9 wherein the fluid comprising a multiplicity of shapeable elongated particles further comprises non-shapeable particles.

15. A method of treating an underground formation penetrated by a wellbore comprising the steps of injecting into the formation a fluid comprising a multiplicity of shapeable elongated particles at a pressure sufficient to fracture the formation, placing the shapeable particles inside a fracture, allowing the shapeable particles to undergo a change in shape and to form collections of reshaped particles heterogeneously distributed within the fracture that mask portions of the fracture faces, and allowing the fracture to close, wherein the injected fluid further contains a source of a formation dissolving agent.

16. The method of claim 15 wherein the shapeable elongated particles are selected from the group consisting of fibers, sheets, platelets, films, ribbons, flakes and mixtures of these shapes.

17. The method of claim 15 wherein the shapeable elongated particles are shrinkable particles.

18. The method of claim 15 wherein the shapeable elongated particles are multicomponent particles.

19. The method of claim 15 wherein the composition of the shapeable elongated particles is selected from the group consisting of polymers and copolymers of the group consisting of polyesters and polyolefins.

20. The method of claim 15 wherein the fluid comprising a multiplicity of shapeable elongated particles further comprises non-shapeable particles.

21. The method of claim 15 wherein the source of a formation dissolving agent is a solid.
